(19) United States
(12) Patent Application Publication
(10) Pub. No.: US 2022/0335495 A1
(43) Pub. Date: Oct. 20, 2022

(54) System and Method for Communication within a Product-oriented Social Network

(71) Applicant: Rex Scott Motes, San Marcos, CA (US)

(72) Inventor: Rex Scott Motes, San Marcos, CA (US)

(73) Assignee: VerifiR, Inc., San Diego, CA (US)

(21) Appl. No.: 17/720,631

(22) Filed: Apr. 14, 2022

Related U.S. Application Data
(60) Provisional application No. 63/201,229, filed on Apr. 19, 2021.

(51) Int. Cl. G06Q 30/06; G06Q 30/02; G06Q 50/00; G06F 16/955

(52) U.S. Cl. CPC G06Q 30/0623; G06Q 30/02; G06Q 50/01; G06F 16/955

(57) ABSTRACT

A computer readable medium is attached to a product and triggers an online interaction when communicatively coupled with a computing device with display to establish an online connection whereby contact can be facilitated within a product-oriented community of socially networked people knowledgeable about the product or products correlated with it. The product is the communication rally point, with contact suggestions initiated by reading the product's medium. The medium can be coupled to the computing device alternatively through Near Field Communication, RFID, or optical pattern coupling techniques, for example. The connection identifies the product and calls an Internet service along with the identifier of the person initiating the communication to retrieve Internet destinations and content from a database containing registered mediums. The display content returned includes people-identifying information in a network to which the person initiating communications belongs and who have used a medium attached to a product like it.

### CROSS-REFERENCE TO RELATED APPLICATIONS

This application claims priority to U.S. Provisional Application Ser. No. 63/201,229 filed on Apr. 19, 2021, which is incorporated herein in its entirety by this reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### TECHNICAL FIELD

The present invention relates generally to the utilization of social networks to facilitate insight and communication among members of the social network(s) in association with physical products and to the connection of physical products to the Internet. More specifically, the invention relates to an automated approach to initiation, execution and follow-up of interactions between physical products, product users, social network members, and Internet services that can add enormous value to the usefulness to the person interacting with or with interest in the physical product and the development of communities with knowledge about the physical product or correlated product attributes.

### BACKGROUND OF THE INVENTION

People often turn to their peer groups to ask for thoughts and advice about a subject matter. Digitally supported social networks have facilitated the persistence, growth, communication of the existence of social networks, and communication within social networks, making interactions among expanding groups of peers quicker and more convenient using mobile technology.

Manufacturers and marketers of products want to facilitate convenience for consumers to learn more about their products and to buy them, and also want to get to know their customers, start strategic partnerships with them, and collect information about distribution and use of their products. Conversely, buyers and users of such products may want to receive additional usage information, open online communication channels with the manufacturer, or subscribe to value-added online services to improve their purchased product beyond just a physical product to one that is a truly valuable solution to satisfy their wants and needs. To accomplish this, technologies exist that can be used to pair a communication mechanism such as an RFID or NFC chipset, QR code or other optical or graphical pattern, with a physical product, such as a sports equipment item (e.g., racket, footwear, apparel), thereby enabling the use of Internet services to uniquely identify the product and potentiate an on-line engagement.

Asking peers for thoughts and advice about a product is a common method used by people to help determine which product they will purchase or use. However, it can be difficult to accomplish this in an informative, quick, convenient, and satisfying manner because:

a. there is no convenient means to quickly determine who in a network may be genuinely knowledgeable about a given product or brand and know with certainty that someone in a network has physically interacted with a product;

b. there is no convenient means to be notified when someone in a network has physically interacted with a product that is of-interest to another person;

c. there is no convenient means to conveniently contact people in a network for thoughts and advice on a product on the basis of their verifiable interaction with a physical product;

d. to discover or identify who in a network may be knowledgeable, it requires speculation, prior knowledge, digital search efforts, and/or other inconveniences resulting from efforts not associated with direct engagement with the specific or related product outfit with a communication mechanism; and

e. the challenges of finding knowledgeable people who can provide useful advice increases uncertainty and/or inconvenience, resulting in less satisfying experiences, missed opportunities to build community, unfulfilled sale/purchase opportunities, and/or more challenging recruitment of participants around a given product.

Many product manufacturers attempt to add value to products by taking advantage of technology that is designed to connect physical products to the Internet with computing devices beyond traditional client computers and servers able to communicate via wired or wireless connections like Ethernet and WiFi. Examples span products across commercial and private use, including industrial pumps, thermostats, dishwashers, and ovens, and are commonly and collectively referred to as the “Internet of Things” (IoT). These products commonly use connectivity technologies like WiFi, Ethernet, Bluetooth, fixed wiring, and Remote Frequency (RF) connections with dedicated hubs or cellular networks.

While use of these types of connections is increasing in use, each have disadvantages. Some non-limiting examples of the disadvantages are summarized below.

### POWER SUPPLY

Most of the aforementioned approaches require a power source and wired cable to connect to the Internet, and the devices typically used by these technologies to connect to the Internet come with their own A/C connections (e.g., TVs, dishwashers, refrigerators) or included batteries (e.g., tire pressure monitoring systems, door locks). Disadvantages exist pertaining to power supply with respect to aspects that include cost, size, and the need for charging devices or access to the battery housing to enable the replacement of batteries.

### AUTHENTICATION

Existing technologies for connecting products to the Internet require pairing and authentication in order to connect to the device. Also, the authentication process is typically time intensive and complex, requiring some user-knowledge of networking technology to properly configure the device, posing an obstacle for fast and convenient Internet connections at a retail store or public park.

### COSTS

Current connection technologies are often prohibitively expensive to implement on items that cost significantly less than higher value items like washers, dryers, and industrial pumps. This is due to the use of technologies like network cards, radio transmitters, radio receivers, and power supplies.

### STATIC CONNECTIONS

Many approaches such as matrix codes or optical patterns only build static connections to specific Internet destinations. The code, once applied to the product, cannot change and the content returned by the connection can only be changed if the destination (e.g., Internet site) is changed. The above exemplary disadvantages individually and in combination create scaling challenges to the widespread adoption of the Internet of Things and thereby make it difficult for manufacturers and brand marketers to enable quick and convenient Internet connectivity to provide social-network content relevant to specific products and those persons who have shown mutual interest in those products by having mutually interacted with them.

One approach, for example, in Publication No. US20140101243A1, titled “Method and apparatus for identifying common interest between social network users,” that is used to identify mutual interests among members of users of a social network is based on matching the users by associating keyword phrases derived by reverse keyword searches of the media content like webpages, posts, messages, pictures, videos, audios, texts, any other type of media content, and logical containers of the media content that the members interact with. A major disadvantage of this approach is that it requires interaction with digital media content like webpages, posts, etc. and does not include the physical product or a means to verifiably indicate the physical product was interacted with. Therefore, the approach in the example cannot be used to accomplish the claims in this invention.

Another approach, for example, referenced in Publication No. US20140101243A1, titled “Method and apparatus for identifying common interest between social network users,” used to identify mutual interests involves users populating a form in which they disclose their interests and the determination made by an algorithm that members of the social network are matches on the basis of common interests, and periodically, target geographic regions. A major disadvantage of this approach is that it requires the users to manually populate a form and does not include interactions with the physical product or a means to verifiably indicate the physical product was interacted with. Therefore, the approach referenced in the example cannot be used to accomplish the claims in this invention.

Another approach, for example, in U.S. Pat. No. 10,748,119B2, titled “Social network search,” used to identify matches among mutual users of a social networking system is to execute search criteria to locate people based on attributes stored with people's profiles. These search criteria can be stored and later automatically executed without user intervention to locate people using the same search criteria who may have subsequently joined. A major disadvantage of this approach is that it searches for users based on their profiles, profile attributes do not typically reference and maintain up-to-date interactions with physical products or a means to verifiably indicate a physical product was interacted with. Therefore, the approach in the example cannot be used to accomplish the claims in this patent.

Another approach, for example, in Publication No. US20090282002A1, titled “Methods and systems for integrating data from social networks,” that may be used to discover who may have knowledge about a product is to search social networks and sites with user review and advocacy data for the product associations to user's name, profile information, rating of a product, a comment, a review, etc. A major disadvantage of this approach is that it also does not include a means to verifiably indicate the physical product was interacted with. Therefore, the approach in the example cannot be used to accomplish the claims in this invention.

The current prior art touches upon the topic of searches for and identifying members of social network users who share mutual interests based on approaches such as reverse keyword search correlations among digital media viewed by social network member, member matching algorithms applied to social network members' user profiles, and execution, storage, and subsequent execution with user intervention of stored search criteria. However, they do not have a means to identify members of social network users who share mutual interests based on their verifiable interaction with physical product.

This invention addresses the above difficulties and other obstacles to provide a solution for consumers to identify and communicate with peers in their social network to ask them for thoughts and advice about a product in an informative, quick, convenient, automated, and satisfying manner. It describes a low-cost and practical option for connecting physical products to the Internet utilizing a communication mechanism with computer-readable instructions: 1) such as but not limited to an RFID or NFC chipset, QR code, or other optical or graphical pattern attached to, on, or in a physical product; 2) such as but not limited to a piece of sports equipment (e.g., racket, footwear, apparel), to make the person (i.e., actor) who engages with the communication mechanism of the product using their reading device; and 3) such as an NFC, QR code, or optical recognition reader in a smartphone, aware of other specific people in their network, or people affiliated with the product or product's brand (e.g., professional athletes, celebrities), that those people have looked at, purchased, identified as a product of interest, or are affiliated with that physical product, products like it or correlated with it, or product brand.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

This invention addresses the above difficulties and other obstacles to provide a solution for consumers to identify and communicate with peers in their social network to ask them for thoughts and advice about a product in an informative, quick, convenient, automated, and satisfying manner. It describes a low-cost and practical option for connecting physical products to the Internet utilizing a communication mechanism with computer-readable instructions that is attached to the product and uniquely identified in a database. The communication mechanism automatically establishes communications with an external computing device having a display screen, provides computer-executable instructions which control the external computing device to initiate communications to an Internet service, provides a unique identifier of the product and unique identifier of the user or device initiating the communication, and retrieves from a database the corresponding Internet destination and content to serve to the display screen. The content returned corresponds to the unique identifier of the product, the unique identifier of the user or device, information of persons in a network of people with which the user is associated by direct first-degree relationships or indirect relationships of second or higher degree of separation, and the prior interactions of such persons with the product.

In a further embodiment, the content returned corresponding to prior interactions of persons in the network are filtered by the view, use or purchase of the product.

In further embodiments, the content returned corresponds to the prior interactions of such persons with products related to the uniquely identified product by comparing or correlating product attributes, branding, product categorizations, physical product attributes, or by comparing or correlating products using machine learning, advanced statistical analysis, or artificial intelligence techniques that are able to identify associations among a diverse range of products and their attributes.

In further embodiments, the content returned is sorted or ranked by one or more criteria, includes product reviews and discussion group postings, and includes protocols to contact a networked person including contact forms, direct messaging, chat, telephone, and email communications.

In a further embodiment, persons in a network of people the user is associated with are identified through a listing of existing contacts on the user's social media networks, interest groups accessed through an external data source, and through direct invitation by the user.

In a further embodiment, the user's interaction with the communication mechanism with computer-readable instructions that is attached to the product triggers a notification to other persons in the user's network that that user has interacted with the product.

### BRIEF DESCRIPTION OF THE DRAWINGS

FIG. 1 is and illustration of one embodiment of the present invention in a retail store setting.

FIG. 2 is an illustration of an exemplary implementation of the present invention, in accordance with one embodiment of the invention.

FIG. 3 is an illustration of a medium implementation on piece of sports equipment, in accordance with one embodiment of the invention.

FIG. 4 is a functional operation diagram, in accordance with one embodiment of the invention.

FIG. 5 is an illustration of a general process flow triggered by the medium attached to a product, sample, or container of a physical product, in accordance with one embodiment of the invention.

FIG. 6 is an illustration of how several samples communicate through a hub with Internet service, in accordance with one embodiment of the invention.

FIG. 7 is an illustration of how the database may be architected to persist and retrieve data, in accordance with the embodiments of the invention.

### DETAILED DESCRIPTION OF THE INVENTION

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

Embodiments of the invention are illustrated by way of examples and not by way of limitation in the figures of the accompanying drawings in which like references indicate similar elements. It should be noted that references to “an” or “one” or “some” embodiment(s) in this disclosure are not necessarily to the same embodiment, and such references mean at least one. Additionally, in the following description of exemplary embodiments, reference is made to the accompanying drawings which form a part hereof, and in which it is shown by way of illustration of specific embodiments in which the invention may be practiced. It is to be understood that other embodiments may be utilized, and structural changes may be made without departing from the scope of the preferred embodiments of the invention.

### Definitions

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

Attribute—a feature, quality, character, method, style, manner, or characteristic of something or ascribed to something or someone

Computer-readable—a signal of a type that can be read and processed by a computing device

Content—information in electronic form

Correlate, correlated, and/or correlation—a relationship existing or discovered between phenomena or things or between mathematical or statistical variables which tend to vary, be associated, or occur together in a way not expected on the basis of chance alone

External computing device—an electronic device that is physically separate from the physical product and is capable of processing computer-executable instructions

Intangible product attributes—those product attributes that exist but that cannot be touched, exactly described, or given an exact value

Interest group—a group of persons having a common identifying interest

Medium—communication mechanism with computer-readable instructions

Physical product attributes—those product attributes that are tangible properties

Prior interaction or prior interactions—the communication of a computing device with the medium attached to a product at some point in time before the current point in time

Product categorizations—the classification of products within classes or groups and subdivisions of classes and groups according to attributes of the products that are the same or similar

Rank, ranked and/or ranking—the position or to position in a list according to a criterion or criteria used to determine the position in a list

Register, registered and/or registering—persisted in a database as an entity with an identifier such that it can be later retrieved from the database via a query

Sort, sorted, and/or sorting—to rank or put in a certain position in a list, or to associate with others, or to order alphabetically, numerically, or alphanumerically

Unique identifier—an electronic identifier of an entity in alphabetic, numeric, or alphanumeric form that is unique among all identifiers in reference to that entity

### Attachment of Communication Mechanism with Computer-Readable Instructions to Product

The communication mechanism with computer-readable instructions (hereinafter “medium”) is attached to a physical product 500. The computer-readable instructions and/or information for facilitating the customer interactions are described in further detail herein. The medium is able to wirelessly signal the instructions via images (e.g., QR code, optical or graphical pattern recognition) or wireless connection (e.g., WiFi, NFC) 504. In one embodiment, a signal presented as an image can be triggered by image recognition or interpretation (e.g., QR code reader) using the computing device 508. In another embodiment, the signal can be transmitted upon reading the medium with NFC receivers within the computing device 508.

### Automatic Communication

The medium automatically communicates with a database server 412 through a networked computing device and identifies itself Upon establishing a communication link (e.g., wired or wireless) between the medium 402 and the computing device which may also serve as a display device 404, the computing device identifies the type of signal input and calls on standard driver code 406 to interpret the information and/or data provided by the signal. The computer readable medium transmits its signals based on the type of communication link.

The standard communication drivers and software will interpret the information as URL address and parameters (e.g., medium id, person id) 408, open an Internet browser or use an application on the local device, and navigate to the URL destination or use another communication protocol per the application on the local device 410 and render content using an associated display device.

### Database Queries for Registered Internet Service Response for Medium, Person, and Maybe Location

With the medium identification number and person id 408, an Internet service 416 is started on a database server 412. The Internet service may determine the origin location of the incoming request 414 via IP or geolocation information. With those pieces of data, the Internet service 416 queries the database 418 if the medium was previously registered. If a positive entry is identified, the Internet service returns an Internet destination address (URL) or content following the communication protocol per the application on the local device that was registered and stored for this particular medium 402 in the database 418. Based on the location information, alternative URLs may be returned based on regional definitions (e.g., URLs for a site in different languages based on the country the medium was connected in). The database can also indicate alternative return URLs or content based on the location information or other parameters. If the medium has not been registered before, the service 416 returns a default URL, for instance to the medium registration page. The content served to the reading client can be dynamic, as described in the “Database Detail and Integration” section below.

### Medium and/or Computing Device can Transmit Location Information

Aside from the information necessary to communicatively couple the medium with the database server, commands can be given to include the geographic location information of the computing device, if available. At a minimum, the database server is able to generally locate the location of the computing device via an Internet Protocol (IP) address of the incoming IP service request 414.

### Database Detail and Integration

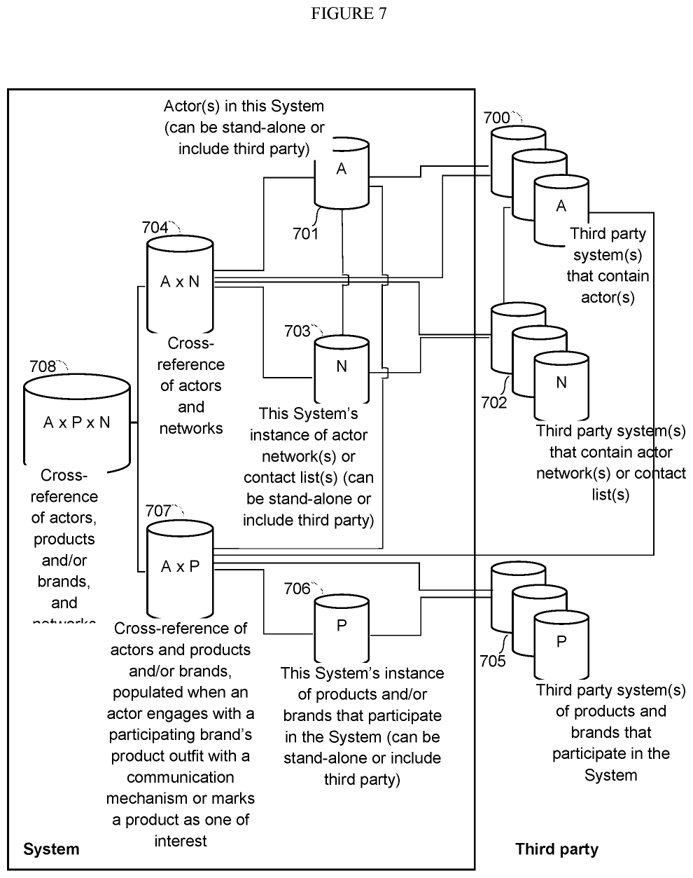

In the database, which may be partially architected as shown in FIG. 7, the medium id can be associated with a physical product. In one embodiment of the present invention, the Internet service 120 and database 124 are integrated in the system 100 with attributes that enable the identification of specific people in a network, or people affiliated with the product 110 or product's brand (e.g., professional athletes, celebrities), who are likely to be knowledgeable about a physical product, products like it or correlated with it, or product brand. When a person 116 engages with the medium of a product using their reading device 132, or when they identify in the system that the product or product's attributes are of interest 115 after requesting content about a product stored in the database 124, the aforementioned system is queried using identifying details, such as the product's or brand's attribute(s) or categorization (e.g., NAICS code, SIC code, sport, terrain of use, soft good, hard good, price range, review rating), and the person's identity 116, and the person is returned a list of specific people in their network, or people affiliated with the product or product's brand (e.g., professional athletes, celebrities), indicating that those people have looked at, purchased, or are affiliated with that physical product, products like it or correlated with it, or product brand. Identification of products correlated with a given product may be the result of machine learning, advanced statistical analysis, or artificial intelligence techniques that are able to identify associations among a diverse range of products and their attributes.

Users may also use the system to discover registered products of interest without having first seen them physically. Because the database includes a registry of products and their relevant parameters (e.g., product, product type, brand) or correlated attributes, users may search the database along those parameters or attributes and use an interface that allows them to log within the database that they are interested in the product or its relevant parameters or correlated attributes 115. The user may also log within the database a request to be notified 506c when someone within their network physically engages or engaged with a product (see section “Database logs the connection and the service request.” Data persisted in this way facilitates an opportunity for users to discover who within their network has physically engaged with an product at some point prior, present, or after the user's own interest in the product, before the user has and without requiring the user to first physically engage with the product. This log also allows users to discover and potentially contact who within their network is interested in the same products or their relevant parameters or correlated attributes.

Example sources for the person's network, which may be persisted in the system or accessible via a third-party system or systems, include but are not limited to the person's own contact lists stored locally on their computing device, contact lists curated for the purposes of using the system, lists of relevant enthusiasts, list built from interest group participants, social media lists, and lists built from the person inviting others to participate in the system. Many methods exist to persist the social network in the system and make it searchable. For example, instructions may be executed on the computing device to iterate through the device's locally stored contact lists and store each contact's attributes in the database, with each contact associated in a cross-reference table associating the person with the network of contacts, as conceptually depicted in FIG. 7. For contact lists and networks stored by services on the Internet, the system may access the services via application programmable interfaces (APIs) to return contacts in the network and store them in the database following the aforementioned method. Alternatively, the APIs can be queried to return known contacts of the person to the system and the system can temporarily store them in system memory. To complete the network of the person combining both the local contact list and those stored by third-party services, queries of the database can also be returned and merged with the API-sourced data that was placed in system memory. In this manner, it would not be necessary to store the third-party contact lists and networks within the system. When a person is using the system with a given registered product to discover who in their network has looked at, purchased, identified as a product of interest, or is affiliated with that physical product, products like it or correlated with it, or product brand, it may be the case that some or none of an person's first-degree contacts (i.e., direct contacts) in a social network meet the search criteria necessary to be discovered and displayed to the person, and the second, third, or higher degree contacts (i.e., the direct contacts of the person's direct contacts—the indirect contacts of the person) may meet the necessary criteria. In this case, subject to permissions and profile settings for participants in the system, both direct and indirect contacts will be discovered and displayed to the person, and for indirect contacts, with an indication to which direct contact the indirect contact belongs. With each returned contact, the system may facilitate a means for the person to contact or notify the people in the list, such as a mobile phone call, VoIP call, video chat, text message, and email. Methods to invite others to participate in the system include but are not limited to inviting others directly from the contact lists or by inviting others while including reference to a particular product, product type, or brand. In this way, the product, product type, or brand can serve as a point of reference to recruit and build community or participants in the system or in programs (e.g., promotions, studies).

Integrations of systems such as a Customer Relationship Management system (CRM) 126 or a Content Management System (CMS) 128 allow for actions like registering products and mediums, logging their distribution and use, assigning dynamic destinations, storing connection requests, capturing connection statistics, providing/pushing relevant content, and initiating follow on actions.

### Dynamic Destination Update

Authenticated users of the present invention, such as brands or manufacturers 206 use a computing device to register 208 the mediums they distribute to retailers or customers 202 of the product 204 with all relevant information. The registration process happens through direct connection with the database server (Tracking System) 212 or via system that is integrated with the database server, such as a customer relationship management system (CRM) 210. Through the ability to directly access the system, the brand or manufacturer 206 can update customer and situation-specific destinations for each individual medium or several mediums in aggregate. These updates can be made even after the medium is attached to a physical product or its distribution when it is no longer under the control of the distributer.

### Database Logs the Connection and the Service Request

Parallel to the retrieval of the destination URL from the database 122, the Internet Service 120 also writes a log entry to the database 122 which may be the database of an integration. This log entry includes the medium id, timestamp of the connection, and location information. The log may also include person id, which can be used to associate a person to a given product. The log can later be analyzed or queried for connection patterns or specific connections, or associate correlating attributes between people, products, and people to products. It can also be used in real-time as the basis for updates to display content or destination URLs, for instance, to present different information each time the medium is connected to the system. This content could be, for instance, a push notification 506c that a different person within the person's network is engaging with a physical product within a given time period.

### Computing Device

The computing device 600 receiving the medium information is equipped with standard communication ports, such as an USB port, optical readers, or NFC receivers. The computing device can be a commercially available tablet computer or cell phone. The only other requirement for the computing device is that it is connected to the Internet via an Ethernet 604 network connection, Wifi, or through a cellular network connection 606, for example. The display can include the display or performance of various kinds of multi-media content. In addition to Web sites, browser scripts, music, video and other content files, such multi-media files can include the establishment of a chat session, Voice over IP (VoIP) phone call, video chat, text message, and email 616.

### Exemplary Embodiment

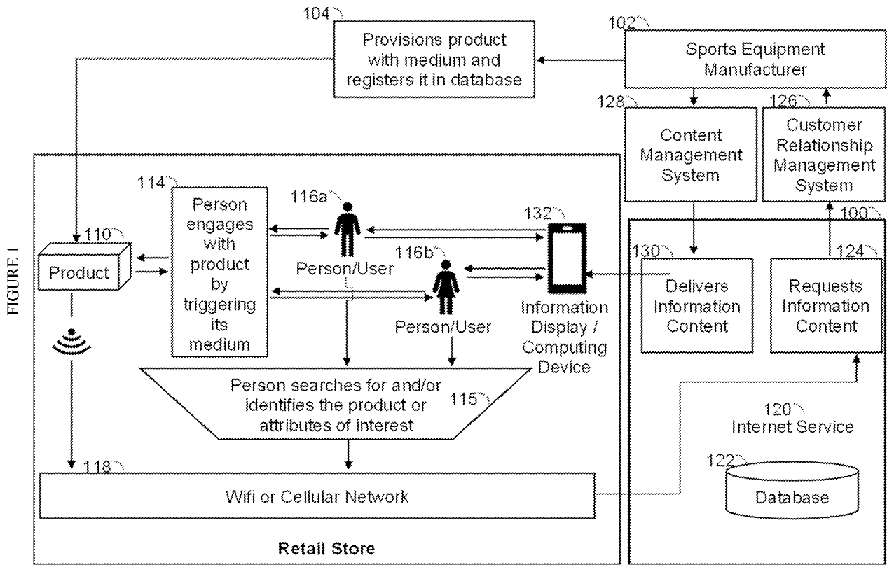

In one exemplary embodiment, the invention can be implemented for sports equipment that is sold at a retail store, as illustrated in the setting in FIG. 1. In this setting, a brand provisions its sports equipment 102 intended for distribution to retailers with a medium storing computer-readable instructions and information thereon, attached to each piece of sports equipment, and registers the equipment in the system 104. In one embodiment, the medium is attached to the sports equipment by the brand manufacturer during the production process.

Person A 116a and Person B 116b have both opted-in to a service in which they can be associated with one another and can be made aware of each other's product interests (i.e., a friends' network searchable by friend association and product or brand association). The system 100 has a means of providing access to or storing the participation of both Person A and Person B in the service, the networks of contacts in which they belong, and medium-containing products with which they each have engaged or have marked in the system as one of interest.

In a retail store, Person A engages with the medium of a piece of sports equipment 114 by reading the RF signal of the medium 110 with their NFC-enabled mobile phone 132 for relevant content to be returned 130. As Person A is a participant in the system, the database 122 logs the engagement event with details such as medium id associated with the product, person id, timestamp, and geolocation.

At some later point in time, Person B either uses the system's interface to query the system for discovery of people within their network 115 or engages with any piece of the same or related sports equipment that is registered in the system 114. At that time, the system queries its database or integrations with other systems (like CRM 126) to discover (receive data) or persist (write) data elements consisting of elements like product SKU, product ID, brand, location, and identity of people associated thereto.

As described in section titled “Database Detail and Integrations,” the system contains the network of participating people in this invention's service. A query 115 is made to the system to discover participating people 130 known to Person B 116b, and for each participant, a list of products 130 that participant has selected or has engaged with. In this query, Person A 116a is identified as being affiliated with the product or product's brand, indicating that they have looked at, purchased, or are affiliated with that physical product, products like it or correlated with it, or product brand. If more people than Person A meet the query criteria, then a list of people may be returned and be logically sorted and ordered (e.g., by relevance, by likelihood of being a quality source of knowledge, by geolocation, by review rating). With each returned participant, the system may facilitate a means for the Person B to contact or notify the people in the list, such as a mobile phone call, VoIP call, video chat, text message, and email 506c.

If Person B had marked the product as one of interest before Person A physically engaged with the medium of it, then Person B may be notified of Person A's engagement with the product at the time Person A engages with the medium of the product.

Now, Person B can contact or be notified of Person A (or vice versa, depending on the timing of events) and other relevant people in an informative, quick, convenient, and satisfying manner to discuss topics pertaining to the specific piece of sports equipment with which they have engaged or marked as one of interest. The participants in the system benefit from a product-oriented community such that advice from knowledgeable people within their network can be made easily accessible to less knowledgeable people in the same network who are considering the purchase or use of the piece of sports equipment. The rally point to facilitate suggested communication to the knowledgeable people is around the product itself, with person-identity suggestions made possible by reading the communication mechanism of the product at some point in time. The sports equipment with the medium can serve as a point of reference to recruit and build community or participants in such a product-oriented advice network to facilitate word of mouth regarding the piece of equipment or brand and to build community around it, benefiting both the individuals in the network and the piece of sports equipment's brand.

In the following description, the present invention is described in the context of an exemplary embodiment for the connection and online integration of a generic retail product along with the use of that product to discover or identify who in a network may be knowledgeable about the given product or brand and can provide useful advice or be part of a community in which that product is relevant. However, it is understood that the present invention is not limited to the sale of products in brick-and-mortar stores and may be used to cause any type of physical products to serve as a point of reference to recruit and build community or participants in such a product-oriented advice network.

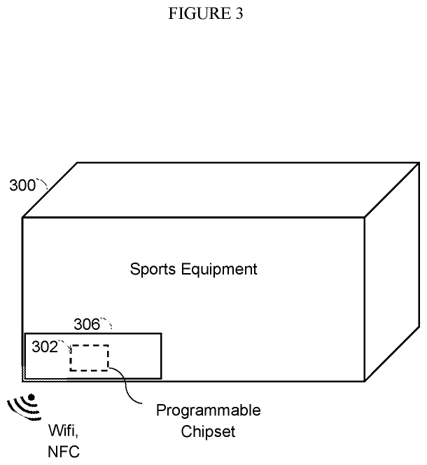

Referring to FIG. 3, there are several potential ways to attach a computer-readable medium 306 to a physical product, such as a piece of sports equipment. In one embodiment, the medium 306 includes an NFC module that transmits a signal to a computing device (not shown). The NFC module is attached to, on, or in a physical product and preferably aesthetically blends-in with the product it is attached to, in, or on. Identifying graphics, imagery, or visibility of the NFC module itself may be used to indicate the location where the NFC module can be found. In one embodiment, the medium attachment is designed or configured to be permanent, and removal attempts risk damaging the product. In other embodiments, the medium may another communication mechanism with computer-readable instructions, such as but not limited to an RFID or QR code.

The attached medium is computer readable (i.e., it can transmit a signal to a computing device). For example, when using an NFC module, it transmits it signal via wireless antenna provided with the medium. The computing device processes the signal. In one embodiment, where the computing device is a tablet computer or smart phone, it may also serve as the display device to provide the interaction content.

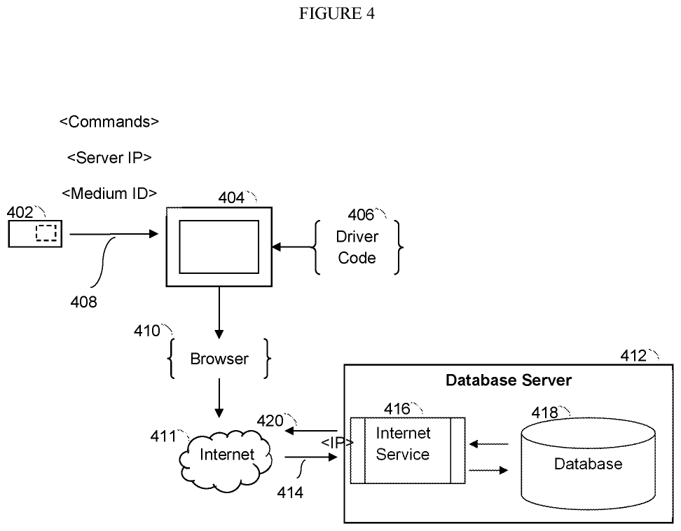

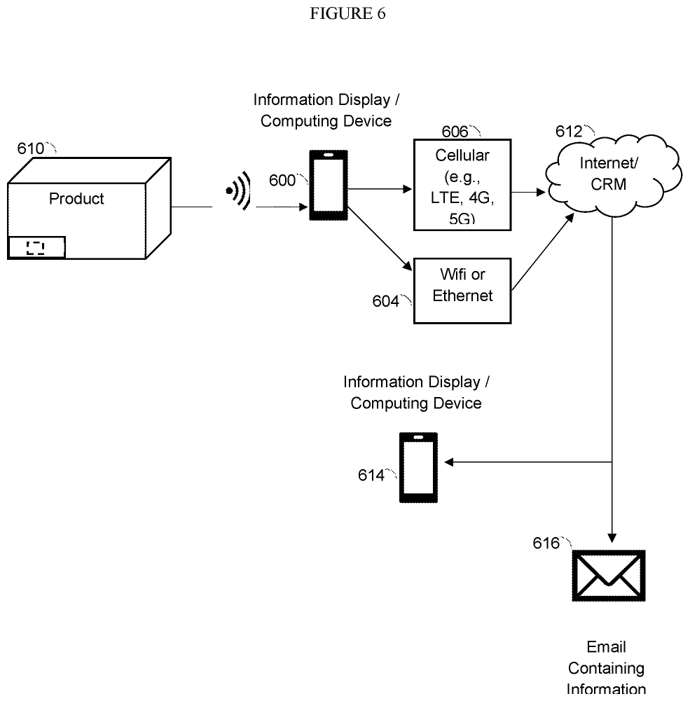

Referring to FIG. 4, the computing device 404 includes a local client (e.g., browser) 410 and is attached to a network with access to the wider Internet, such as a WiFi connection or a connection through a cellular network, as described in further detail with respect to FIG. 6 below. The browser 410 executes appropriate commands and protocols to allow the device 404 to communicate via the Internet 411 using known techniques. In an embodiment an application on the local device other than a browser is used, such as a locally installed application (e.g., a smart phone app), the application uses the appropriate commands and protocols per the application on the local device.

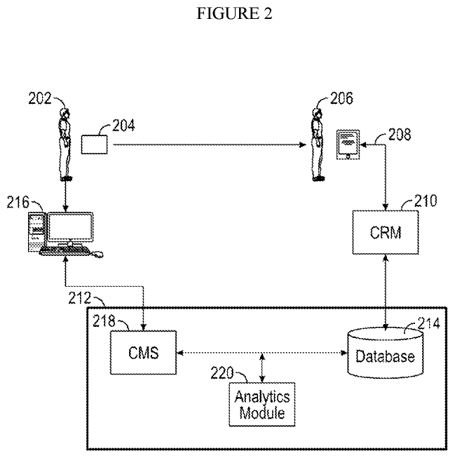

The computing device sends an Internet service request with URL and identifying information through the Internet 411 to a database server 412. In its processing unit the database server 412 runs an Internet service 416 managed by a standard Internet service software, such as Internet Information Server, Apache Tomcat, or similar. The Internet service listens for incoming requests and processes them when they arrive. The main processing task is to query a database 418 that either resides on the same physical machine or on a separate database engine device. The engines for database 418 and Internet service 416 are connected in a network and together considered the database server 412 in the present invention. The database server 412 can also be connected to third-party systems, such as a Customer Relationship Management system (CRM), data analytics systems (see FIG. 2), or machine learning, advanced statistical analysis, or artificial intelligence systems. Such systems can reside on the same computing devices as the database server or, more likely, are connected with the database server 412 over a network or the general Internet.

The medium 402 further carries the connectivity instructions programmed in a suitable format and readable to be interpreted by the computing device and automatically executed after connection of the medium with the computing device 404 and its connection with a central Internet service 416, for example, as follows:

Type: URI record: (0x55)

Protocol: https:// (0x04)

Format: NFC Well Known (0x01)

Defined by RFC 2141, RFC 3986

Value: https://deepskyhost.com/9992000244

Raw value: https://deepskyhost.com/9992000244

From this point the Internet service 416 will continue the system functionality process.

In an embodiment with an active wireless connection, like WiFi or Bluetooth, the medium 402 will send the Internet service URL to the computing device. The medium will be equipped with readily available sender circuits (WiFi or Bluetooth) and a small power source, such as a Lithium-ion battery. The more likely way to read the medium wirelessly by the computing device is through a passive signal, such as remote frequency (RF) or matrix barcode. The computing device 404 will decode the signal using standard operating system software as provided by most versions of Apple's iOS or Google's Android operating systems. In one embodiment, the signal can have the following structure:

https://deepskyhost.com/?id=9992000001

or route through an abbreviated URL server to minimize size requirements of the signal:

https://dsky.link/?id=9992000001

In both cases the standard operating software of the computing device will identify the signal as a URL address and open it in a browser 410, thus connecting to the Internet service 416.

When a connection occurs with the Internet service, the present invention has the ability to transfer the location information of the computing device, and hence the physical product the medium is attached to. Such a transfer can be accomplished through a POST request and an associated server-sided script like:

https://deepskyhost.com/postgps/?id=9992000001

The Internet service 416 script can alternatively analyze the Internet protocol (IP) address origination of the computing device, as for example in:

https://maps.google.com/maps?q=%LOCATION

With the received connection of the medium, its id number, the identification of the person or device initiating the connection (e.g., by virtue of an identifying cookie on the browser), and other parameters, the Internet service 416 connects to the database 418 that contains the registered medium id numbers, destination URLs, association of people and their contact networks, association of people and products, and, if applicable, other criteria like alternative destinations based on location.

If a positive medium id entry in the database is identified, the Internet service returns the Internet destination address (URL). Otherwise, the Internet service returns a default destination address. If the database also identifies the product is associated with another third-party person who is in the network of the person or device initiating the connection, then a portion the content shown on the device through the Internet destination address (URL) will include the identification of the third-party person (or people, if multiple third-parties meet the query criteria), possibly also displaying one or more contact methods to the third party (e.g., mobile phone call, VoIP call, video chat, text message, email).

In one embodiment, a simple Internet server 416 query to the database 418 can be implemented as follows:

SELECT URL FROM DB.DBLinkID where DBLinIdD=MediumID;

The returned URL is then used to redirect 420 the requesting browser 410 to the destination content for the specific product and medium 402.

For the content shown on the device through the Internet destination address (URL) if the database also identifies the product is associated with another third-party person who is in the network of the person or device initiating the connection, it can be sourced as follows, referring to FIG. 7:

SELECT PRODUCT_SKU FROM DB.PRODUCTSKU_XREF where
ProductID=MediumID; /*705, 706*/
SELECT PersonInNetworkID FROM DB.PERSONNETWORK_XREF
where
PersonID=DeviceID; /*700, 701*/
SELECT DISTINCT NAME, CONTACT_INFO FROM

| | |
|---|---|
| DB.ACTORPRODUCTNETWORK_XREF | where |
| PRODUCT=PRODUCT_SKU | and |

PersonID=PersonInNetworkID; /*708*/

At the same time the Internet service 416 fulfills the incoming request, it makes a connection log entry to a separate table of the database 418 including the medium id, timestamp of the connection, and location information. It also makes product-interest database entry to record that the person or device initiating the connection has looked at the product.

A separate service or an integration with the main Internet service 416 can periodically analyze the connection log and change destination URLs in the database 418 based on the number of successful connections of the medium 402 with the database server 412. The log can also be used in real-time as the basis for updates to display content or destination URLs, for instance, to present different information each time the medium is connected to the system. Such content could be contextually relevant, for example, to offer services, upsell products, or encourage behavior to use the product.

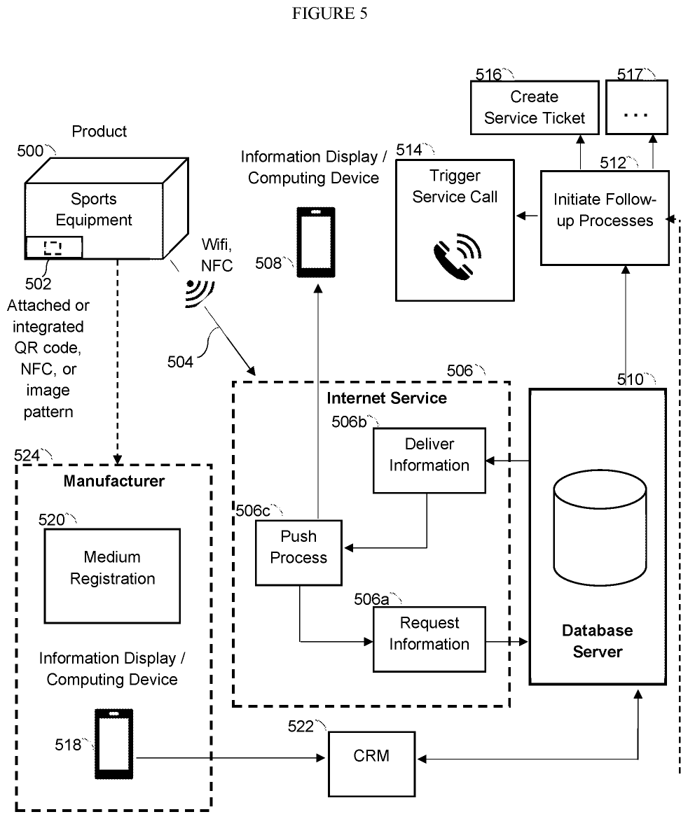

Referring to FIG. 5, a general process flow is illustrated. Authenticated users of the system, such as manufacturer can use a separate computing device 518 to perform registration 520 of the physical product 500 having an attached medium 502. The product 500 with attached medium 502 can thereafter be distributed to retailers. The computing device 518 can be, for instance, a laptop PC, a tablet PC, a smart phone, or a desktop PC. The connection to the database server can be established through the Internet and via local network or cellular network.

In one embodiment, the registration process is initiated through a direct connection with the database server 510 or, alternatively, via a customer relationship management system (CRM) 522, which can be part of the same system as the database server 510 or, alternatively, located in a separate system. After accessing the database server 510, either directly or via CRM 522, the manufacturer 524 can update customer- and/or situation-specific destinations for each individual medium 502 or several mediums in aggregate. These updates can be made even after the medium is attached to a physical product 500 or its distribution when it is no longer under the control of the distributer. The destination can be either entered directly into the database 510 together with the medium 502 id number, or through use of preset destination URLs based on specific criteria. Criteria can include, for instance, customer types, products or product types, production lot numbers, or interaction types. A typical electronic registration form may be provided as follows:

| Product and Lot Reference: | RS140 Rack Server | | |
|---|---|---|---|
| Contact: | Jane Doe | | |
| Start ID: | 99910000138 | | |
| End ID: | 99910000181 | | |
| | Save | Save & New | Cancel |

With the medium registration completed, the physical product 500 with the attached medium 502 is ready to be used. The signal from the medium 504 triggers an Internet Service 506 (further detailed in FIG. 6) by requesting content from the Internet Service 506 (step 506a). In response, the Internet Service delivers the requested or predetermined content (step 506b) through a push process 506c (the push process may accommodate a variety of protocols including SMS and SMTP) to a computing device which may also serve as a display device 508.

Further services or integrations with the main Internet service 506 can trigger follow-up processes 512, such as generation of service calls 514 and service tickets 516, or other predetermined functions 517 by calling process services on the same or different database servers. Such services can reside on the Internet or in a private network, for instance as part of a customer relationship management system (CRM) 522. In this invention, when a person engages with the medium using their reading device, or when they identify in the system that the product, product type, or brand is one of interest, the aforementioned systems are queried using identifying details, such as the product's or brand's attribute(s) and the person's identity, and the person is returned a list of specific people in their network, or people affiliated with the product or product's brand (e.g., professional athletes, celebrities), indicating that those people have looked at, purchased, or are affiliated with that physical product, products like it or correlated with it, or product brand. The list of people displayed may also have one or more contact methods shown alongside them (e.g., mobile phone call, VoIP call, video chat, text message, email).

In one embodiment, the integration with a CRM or other system is accomplished through passing of inbound and outbound messages between the CRM system 522 and the database server 510.

Messages to integrate an external CRM system and the database server can be sent in Web Services Description Language (WSDL), for example, which are parsed and acted on by each of these systems. A simplified implementation of these integration messages is shown below:

<!--
CRM Outbound Notification Web Services API Version 1.0
Generated on 2014-10-21 22:15:20 +0000.
-->
definitions xmlns=“http://schemas.xmlsoap.org/wsdl/” xmlns
:soap=“http://schemas.xmlsoap.org/wsdl/soap/”>
<types>
<schema xmlns=“http://www.w3.org/2001/XMLSchema” elementFor
mDefault=“qualified”>...</schema>
</types>
<!-- Method Messages -->
<message name=“notificationsRequest”>...</message>
<message name=“notificationsResponse”>...</message>
<!-- PortType -->
<portType name=“NotificationPort”>...</portType>
<!--...-->
<binding name=“NotificationBinding” type=“tns:NotificationP
ort”>
<soap:binding style=“document” transport=“http://schemas.xm
lsoap.org/soap/http”/>
<operation name=“notifications”>
<soap:operation soapAction=“”/>
<input>...</input>
<output>...</output>
</operation>
</binding>
<!-- Service Endpoint -->
<service name=“NotificationService”>
<documentation>Notification Service
Implementation</documentation>
<port binding=“tns:NotificationBinding” name=“Notifica
tion”>
<soap:address location=“https://deepskyhost.com/OMSolu
tion/DSLNotificationService.asmx”/>
</port>
</service>
</definitions>

While most redirection and integration actions can be handled by Internet services 506 and Content Management Systems (described in FIG. 2), in one embodiment, some display actions of content use local application clients and communication protocols and the installed handling software and the content types accepted by the display device 508. For instance, pdf type files might be returned as the relevant content from the Internet service 506, but the decision concerning how to display that content can be left to the pdf viewer installed on the display device 508. In one embodiment, the service or web page at the redirected destination URL checks for available display software on the display device 508 and, if necessary, enables the download of the software required.

Referring to FIG. 6, in one embodiment, the computing device 600 receiving the medium information can be equipped with standard communication ports, such as NFC receivers. The computing device is connected to the Internet or CRM 612 either via a wireless Ethernet 604 network connection or through a cellular network connection 606, for example.

While various embodiments of the invention have been described above, it should be understood that they have been presented by way of example only, and not of limitation. Likewise, the various diagrams may depict an example architectural or other configuration for the invention, which is done to aid in understanding the features and functionality that can be included in the invention. The present invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Although specific terms are employed herein, they are used in a generic and descriptive sense only and not for purposes of limitation. Likewise, the various figures or diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations.

One or more of the functions described in this document may be performed by one or more appropriately configured modules located in one or more nodes as described above. As used herein, a “module” can refer to hardware firmware, software and any associated hardware that executes the software, and any combination of these elements for performing the associated functions described herein. Additionally, as would be apparent to one of ordinary skill in the art, the various modules may be discrete modules; however, two or more modules may be combined to form a single module that performs the associated functions, or the functions of a single module may be divided among two or more modules, according to various embodiments of the invention.

Additionally, one or more of the functions described in this document may be performed by means of computer program code that is stored in a “computer program product,” “non-transitory computer-readable medium,” and the like, which is used herein to generally refer to media such as, memory storage devices, or storage units. These, and other forms of computer-readable media, may be involved in storing one or more instructions for execution by a processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

I claim:

1. A method of providing a product to a user to initiate an online interaction with an Internet service the method comprising:
registering the product, a unique identifier associated with the product in at least one database; and
providing a computer-readable medium device attached to the product or packaging of the product to the user, wherein the computer-readable medium device is configured to be communicatively coupled to an external computing device having a display screen, and stores computer-executable instructions, at least one Uniform Resource Identifier (URI) address, and the unique identifier; and
initiating the online interaction with an internet service by the user when scanning the computer-readable medium device with the external computing device;
wherein the user of external computing device or the external computing device itself can be identified with a unique identifier of the person or device,
wherein upon establishing communications with the external computing device, the computer-executable instructions and unique identifier of the product and unique identifier of the user or device initiating the communication is automatically provided to the external computing device,
wherein the computer-executable instructions control the external computing device to initiate communications with an Internet service that corresponds to the at least one URI address, and
wherein the Internet service retrieves content corresponding to the unique identifier of the product, the unique identifier of the user or device, information of persons in a network of people the user is associated with, and the prior interactions of such persons with products related to the product, from at least one database and provides such content to a predetermined computing device configured to receive content from the Internet service.

2. The method of claim 1, wherein an association is defined as direct first-degree relationships between the user and the person in his network and/or as an indirect relationship of second or higher degree of separation between the user and the person in his network.

3. The method of claim 2, wherein the content retrieved by the Internet service corresponds to the degree of separation between the user and the person in his network.

4. The method of claim 1, wherein the prior interactions of persons in the network are limited by the view, use or purchase of the product.

5. The method of claim 1, wherein the prior interactions of persons in the network include products related to the uniquely identified product by comparing or correlating intangible product attributes, physical product attributes, and/or product categorizations.

6. The method of claim 5, wherein product relationship is established by comparing or correlating intangible product attributes, physical product attributes, and/or product categorizations.

7. The method of claim 5, wherein product relationship is established by comparing or correlating products using machine learning, advanced statistical analysis, or artificial intelligence techniques that are able to identify associations among a diverse range of products and their intangible product attributes and/or their physical product attributes.

8. The method of claim 1, wherein the content retrieved by the Internet service can be sorted or ranked by at least one criterion.

9. The method of claim 1, wherein the content retrieved by the Internet service includes product reviews or discussion group postings.

10. The method of claim 1, wherein the content retrieved by the Internet service includes protocols to contact a networked person including contact forms, direct messaging, chat, phone, video, and email communications.

11. The method of claim 1, wherein persons in a network of people the user is associated with are identified through a listing of contacts on the user's external computing device.

12. The method of claim 1, wherein persons in a network of people the user is associated with are identified through a listing of existing contacts on the user's social media networks.

13. The method of claim 1, wherein persons in a network of people the user is associated with are identified through a listing of interest groups accessed through an external data source.

14. The method of claim 1, wherein the user's interaction with the product triggers a notification to other persons in the user's network.

15. The method of claim 1, wherein the computer-executable instructions further instruct the external computing device to send information indicative of a geographic location of the external computing device to the predetermined Internet service.

16. The method of claim 1 wherein the content is dynamically updated prior to being delivered to the predetermined computing device.

17. The method of claim 1 wherein the predetermined computing device comprises the external computing device that is communicatively coupled to the computer-readable medium device.

18. The method of claim 1 wherein the content comprises information concerning a further service or product that can be provided to the user of the product.

19. The method of claim 1 further comprising providing a printed code on a surface of the computer-readable medium device readable by optical means of the external computing device.

20. The method of claim 1 further comprising providing an electro-magnetic signal by the computer-readable medium device in the form of an RFID or NFC signal.
